(19) United States
(12) Patent Application Publication
(10) Pub. No.: US 2026/0016131 A1
(43) Pub. Date: Jan. 15, 2026

(54) ADJUSTABLE MOUNTING STRUCTURE FOR LIGHT FIXTURE

(71) Applicant: Kohler Co., Kohler, WI (US)

(72) Inventors: Maxwell Wasscher, Grafton, WI (US); Douglas J. Diemel, JR., Kohler, WI (US); Xiaodong Su, Shanghai (CN)

(21) Appl. No.: 19/259,649

(22) Filed: Jul. 3, 2025

Related U.S. Application Data
(60) Provisional application No. 63/669,395, filed on Jul. 10, 2024.

(51) Int. Cl. F21S 8/00; F21V 21/02

(52) U.S. Cl. CPC F21S 8/033; F21V 21/02

(57) ABSTRACT

A light fixture includes a sconce, a mounting plate, a backplate, and a buckle. The sconce includes a symmetrical portion and an asymmetrical portion. The mounting plate includes a circular cross-section in a circumferential direction. The backplate includes a ramped surface configured to support the light fixture via the mounting plate, and the backplate has a circular cross-section in a circumferential direction. The buckle is configured to latch on the buckle and be supported by the mounting plate via the buckle so that the buckle applies a frictional force to oppose a rotation force placed on the light fixture by the asymmetrical portion of the sconce.

### CROSS REFERENCE TO RELATED APPLICATIONS

The present application claims the benefit of U.S. Provisional Patent Application No. 63/669,395, filed Jul. 10, 2024, which is incorporated herein by reference in its entirety.

### FIELD

The present application relates generally to light fixtures.

### BACKGROUND

Generally speaking, the installation of a light fixture may be difficult. One or more screw holes in a bracket for the light fixture must be aligned with corresponding holes in a mounting bracket. One complication is that the installation is often made on a ceiling or high on a well, which is difficult to reach. A further complication is the light fixture itself is often heavy. The following embodiments reduces the challenges in the installation of light fixtures.

### BRIEF DESCRIPTION OF THE DRAWINGS

Exemplary embodiments are described herein with reference to the following

### DRAWINGS

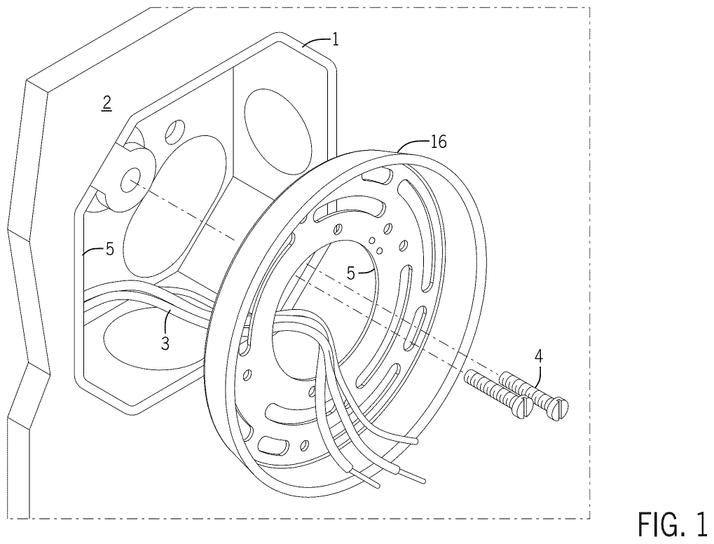

FIG. 1 illustrates an example installation of a mounting plate for a light fixture mounting system.

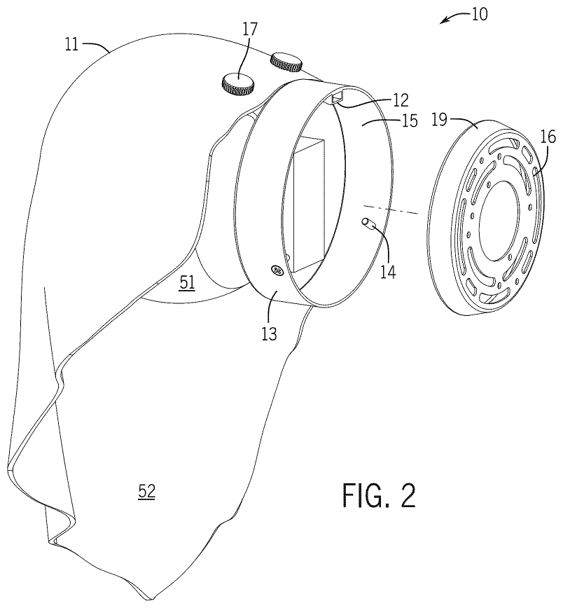

FIG. 2 illustrates a light fixture mounting system including a reversed buckle and a tilting surface.

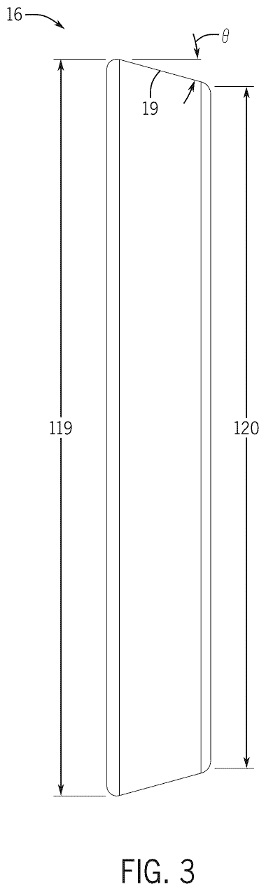

FIG. 3 illustrates a cross section of the mounting plate of the light fixture mounting system of FIG. 2.

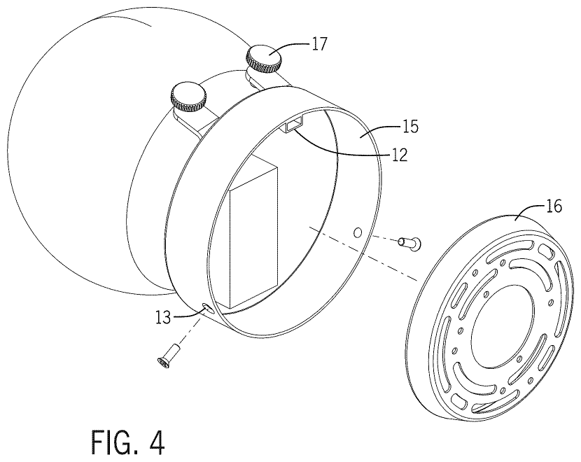

FIG. 4 illustrates another view of the light fixture mounting system of FIG. 2.

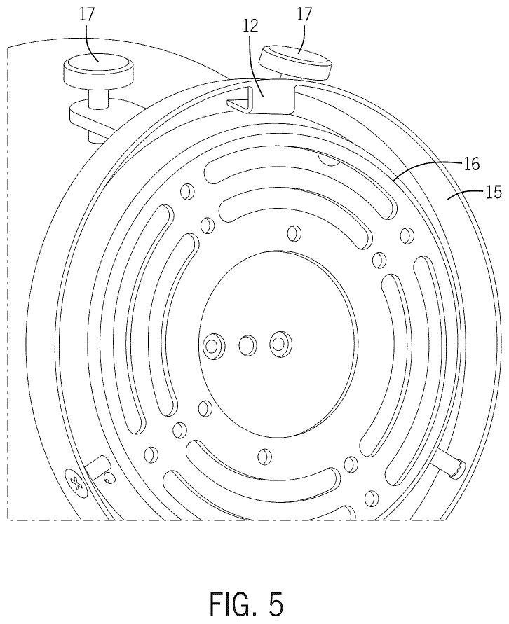

FIG. 5 illustrates an example light fixture mounting system including a spring buckle.

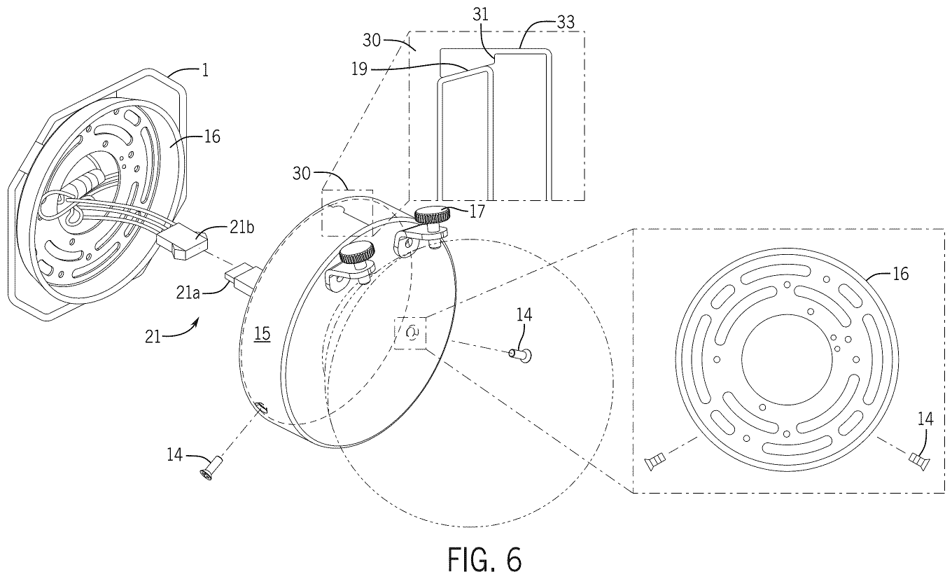

FIG. 6 illustrates another view of the light fixture mounting system of FIG. 2.

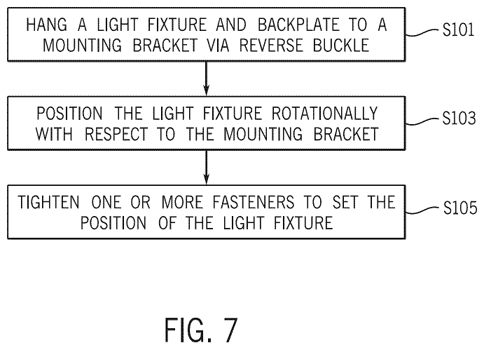

FIG. 7 illustrates a flow chart for the assembly of the light fixture mounting system of FIG. 2.

### DETAILED DESCRIPTION

Before turning to the figures, which illustrate certain exemplary embodiments in detail, it should be understood that the present disclosure is not limited to the details and methodology set forth in the description or illustrated in the figures. It should also be understood that the terminology used herein is for the purpose of description only and should not be regarded as limiting.

FIG. 1 illustrates an example installation of a mounting plate 16 for a light fixture mounting system. The light fixture mounting system installs or mounts a light sconce to a wall. An electrical outlet box 1 may be semi-permanently mounted to a surface 2 (e.g., wall or ceiling) and/or one or more support structures such as wall studs. The mounting plate 16 is coupled to the electrical outlet box 1 using one or more bolts, screws, or other fasteners 4. An electrical connector (e.g., wire 3 or set of wires including hot, neutral, and ground) may be supplied through one or more openings 5 in the electrical outlet box 1 and the mounting plate 16. With the mounting plate 16 affixed to the surface 2, the following embodiment for a light fixture mounting system may be implemented. Additional, different or fewer components may be included.

FIG. 2 illustrates a light fixture mounting system 10 including a buckle and a tilting surface, which may be referred to as a ramped surface. The light fixture mounting system 10 may include a light fixture 11, a backplate 15, and the mounting plate 16. The outer circumference of the back plate 15 is circular, and accordingly the back plate 15 has a circular cross-section in the circumferential direction. The circular cross-section includes the circumference of the backplate 15. The outer circumference of the mounting plate 16 is circular, and accordingly the mounting plate 16 has a circular cross-section in the circumferential direction. The circular cross-section includes the circumference of the mounting plate 16. The light fixture 11 includes one or more openings for bolts 17 or other fasteners to couple the light fixture 11 to the backplate 15. Additional, different or fewer components may be included.

The light fixture 11 includes a sconce, which may include a symmetrical portion 51 and an asymmetrical portion 52. The asymmetrical portion 52 may have a mass/weight greater than the symmetrical portion 51. The mass/weight of the asymmetrical portion 52, in certain orientations, may place a rotational force or torque on the junction between the backplate 15 and the mounting plate 16. One orientation that illustrates this is when the asymmetrical portion 52 is mounted to extend horizontally from the symmetrical portion 51. The following examples provided a secure fit to overcome the rotation force placed on the junction between the backplate 15 and the mounting plate 16 from the mass/weight of the asymmetrical portion 52. In one example, the rotational force tends to rotate the light fixture out and away from the wall. In another example, the rotation force tends to rotate the light fixture circumferentially or in the plane of the mounting plate 16 and the backplate 15. Any shape of sconce may be used.

The backplate includes a buckle 12 and one or more mounting holes 13. Corresponding to the mounting holes 13, one or more fasteners 14 (e.g., mounting screw 14) are configured to couple the backplate 15 to the mounting plate 16.

The fasteners 14 do not mate with holes in the mounting plate 16. Instead, the fasteners 14 pass though the backplate 15 and mounted with the slanted surface 19 (ramp) of the mounting plate 16. FIG. 3 illustrates a radial cross section of the mounting plate 16. The slanted surface 19, or tilted surface, is the outer perimeter surface of the mounting plate 16. The slanted surface 19 may be defined by an inner diameter 119 (e.g., the inner side near the electrical outlet box 1) and an outer diameter 120 (e.g. the outer side near the light fixture 11) such that the inner diameter is less than the outer diameter. In other words, the slanted surface 19 slants inward toward the center of the mounting plate 16 and the backplate 15 in the direction of installation of the light fixture 11, which is a direction toward the wall or other mounting surface. As shown in FIG. 3, the mounting plate 16 includes an inner diameter circumference and an outer diameter circumference and the slanted surface 19 extends from the inner diameter circumference to the outer diameter circumference. An angle, theta Θ, is between the horizontal and the slanted surface 19. Examples for theta include 20 degrees, 30 degrees, or 40 degrees. Example ranges for theta include 10 to 50 degrees.

The fasteners 14 may be tightened to press against the slanted surface 19 between the inner diameter and the outer diameter and anywhere peripherally or circumferentially around the slanted surface 19 of the mounting plate 16.

Because the mounting plate 16 may be fastened against the backplate 15 at any circumferential position, the light fixture 11 may be effectively positioned rotationally. That is, because the backplate 15 and the mounting plate 16 have circular cross-sections, that may be rotated. Thus, any manufacturing anomalies or other asymmetric details in the light fixture 11 may be adjusted with respect to the installation surface 1 or the vertical axis.

FIG. 4 illustrates another view of the light fixture mounting system of FIG. 2. In FIG. 4, the buckle 12 (e.g., reverse buckle or block) is illustrated to latch the backplate 15 to the mounting plate 16. The backplate 15 is configured to latch on the buckle 12 and be supported by the mounting plate 16 via the buckle 12. The buckle 12 may be a block of metal welded to the mounting plate 16. The buckle 12 may include a reverse buckle that provides a securing force in the reverse direction (opposed to the installation direction) to the mounting plate 19 from the backplate 15. The buckle 12 may be a block that provides a friction force against the slanted surface 19 of the mounting plate 16.

The light fixture mounting system 10 may be applied to a horizontal ceiling or a vertical wall. The backplate 15 may be first hanged on the mounting surface and supported by the buckle 12. The fasteners 14, which may already be thread into the backplate 15 may be tightened against the mounting plate 16. However, only one person is required for installation.

FIG. 5 illustrates a spring buckle 42 for the light figure mounting system. In the embodiment shown in FIG. 5, the spring buckle 42 replaces the buckle 12. The spring buckle is a bent tab configured to act light a spring. The spring buckle 42 increases the frictional forces between the mounting plate 16 and the backplate 15. The spring buckle 42 also flexes to provide a small amount of movement between the mounting plate 16 and the backplate 15 to provide a tolerance to accommodate screw mounting deviations.

FIG. 6 illustrates another view of the light fixture mounting system of FIG. 2. In FIG. 6, a profile view 30 illustrates the slanted surface 19 adjacent to a level surface 33. In this example, the slanted surface is 20 degrees to the horizontal. The slanted surface 19 and level surface 33 may be divided or defined by a lip 31 or step. Thus, the level surface 33 has a diameter greater than the outer diameter of the slanted surface 19.

Also, illustrated in FIG. 6 is a quick connector 21. The quick connector 21 is a plastic plug or another type of adapter that allows an electrical connection from the wires at the wall outlet to the fixture. The backplate 15 may be mechanically coupled (e.g., pre-installed) to a quick connector 21a (fixture side quick connector) that is configured to mate with a quick connector 21b (wall side quick connector) coupled to the wiring system of the building. The connection between quick connector 21a and quick connector 21b provides electrical power to the light fixture.

FIG. 7 illustrates a flow chart for the assembly of the light fixture mounting system of FIG. 2. Additional, different or fewer acts may be included.

As a preliminary act, a mounting bracket is provided at an installation location of the light fixture. The mounting bracket may be installed at a pre-existing wall outlet.

At act S101, a light fixture and/or backplate are hanged to the mounting bracket that supports the light fixture and/or backplate. The light fixture rests on the mounting bracket so that the mass/weight of the light fixture is held by the mounting bracket. The light fixture is rotatable with respect to the mounting bracket.

At act S103, the light fixture is rotated to position the light fixture with respect to the mounting bracket. The installation position may be vertical such that the center of gravity of the light fixture is at the lowest possible point. The installation position may be at an off balance position such that the center of gravity of the light fixture is at a point other than the lowest possible point. The installation position may be a horizontal position such that the center of gravity of the light fixture is alight with a theoretical horizontal line that intersect a center or near a center of the mounting bracket. Any orientation is possible.

At act S105, one or more fasteners are tightened to set the position of the light fixture with respect to the mounting bracket. Using this technique, a single installer can rest the light fixture on the mounting bracket then rotate the light fixture and finally secure the light fixture. No second person, second pair of hands, or mechanical braces or brackets are needed.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

When a component, element, device, or the like of the present disclosure is described as having a purpose or performing an operation, function, or the like, the component, device, or element should be considered herein as being “configured to” meet that purpose or to perform that operation or function.

What is claimed is:

1. A light fixture comprising:
a sconce having a symmetrical portion and an asymmetrical portion;
a mounting plate having a circular cross-section in a circumferential direction;
a backplate including a ramped surface configured to support the light fixture via the mounting plate, wherein the backplate has a circular cross-section in a circumferential direction; and
a buckle, wherein the backplate is configured to latch on the buckle and be supported by the mounting plate via the buckle, wherein the buckle applies a frictional force to counter a rotational force from the asymmetrical portion.

2. The light fixture of claim 1, wherein the buckle is a reverse buckle extending from the backplate.

3. The light fixture of claim 1, wherein the buckle is a spring buckle formed from a tab bent inward into the back plate.

4. The light fixture of claim 1, wherein the ramped surface ramps inward toward a center of the mounting plate in a direction of installation of the light fixture.

5. The light fixture of claim 1, wherein the ramped surface meets a horizonal line at an angle Θ in a range of 10 to 50 degrees.

6. A mounting apparatus for a light fixture, the mounting apparatus comprising:
a mounting plate having a circular cross-section in a circumferential direction;
a backplate including a ramped surface configured to support the light fixture via the mounting plate, wherein the backplate has a circular cross-section in a circumferential direction; and
a buckle, wherein the backplate is configured to latch on the buckle and be supported by the mounting plate via the buckle.

7. The mounting apparatus of claim 6, wherein the buckle is a reverse buckle extending from the backplate.

8. The mounting apparatus of claim 6, wherein the buckle is a spring buckle formed from a tab bent inward into the back plate.

9. The mounting apparatus of claim 6, further comprising:
at least one fastener configured to couple the backplate to the mounting plate by contacting the ramped surface.

10. The mounting apparatus of claim 6, wherein the ramped surface ramps inward toward a center of the mounting plate in a direction of installation of the light fixture.

11. The mounting apparatus of claim 6, wherein the ramped surface ramps inward toward a center of the mounting plate in a direction of a wall outlet.

12. The mounting apparatus of claim 6, wherein the mounting plate includes an inner diameter circumference and an outer diameter circumference and the ramped surface extends from the inner diameter circumference to the outer diameter circumference.

13. The mounting apparatus of claim 6, wherein the ramped surface meets a horizonal line at an angle Θ.

14. The mounting apparatus of claim 13, wherein the angle Θ is in a range of 10 to 50 degrees.

15. The mounting apparatus of claim 13, wherein the angle Θ is approximately 20 degrees.

16. The mounting apparatus of claim 13, wherein the light fixture includes a symmetrical portion and an asymmetrical portion, wherein the buckle applies a frictional force to oppose a rotation force placed on the light fixture by the asymmetrical portion.

17. A method for installation of a light fixture, the method comprising:
providing a mounting bracket including a buckle at an installation location of the light fixture;
resting the light fixture and a backplate to the mounting bracket, wherein the backplate is configured to latch on the buckle;
rotating the light fixture and the backplate to an installation orientation; and
fastening one or more fasteners to set the light fixture at the installation orientation with respect to the mounting bracket.

18. The method of claim 17, wherein the buckle is a spring buckle formed from a tab bent inward into the backplate.

19. The method of claim 17, wherein the installation orientation is a horizontal orientation.

20. The method of claim 17, wherein the light fixture includes an asymmetrical portion and a symmetrical portion.
